(19) United States
(12) Patent Application Publication
(10) Pub. No.: US 2015/0379567 A1
(43) Pub. Date: Dec. 31, 2015

(54) SYSTEM AND METHOD FOR DELIVERING TARGETED CONTENT TO CONSUMERS

(71) Applicant: Leonard Andre' Leassear, Woodbridge, VA (US)

(72) Inventor: Leonard Andre' Leassear, Woodbridge, VA (US)

(21) Appl. No.: 14/319,274

(22) Filed: Jun. 30, 2014

(51) Int. Cl. G06Q 30/02

(52) U.S. Cl. CPC G06Q 30/0255; G06Q 30/0267

(57) ABSTRACT

A system for delivering targeted content to consumers includes a wishlist database containing user wishlists and an institution database containing information items provided by institutions. The system further includes a computer having an analyzer that determines if an item on a user wishlist matches an item in the institution database. The computer further includes a display that graphically displays items in the institution database that match items on the user wishlist. The computer further includes an updater that updates the wishlist database and institution database with changes from users and institutions.

### TECHNICAL FIELD

The system and method described herein relate to the field of advertising, more particularly, to the field of targeted advertising.

### BACKGROUND

There is a gap between consumers with mobile devices and those who want to advertise or provide content to them. Current methods of mobile platform content delivery cannot take the near real-time changes of consumers' demands into account. Moreover, small businesses are unable to reach these consumers in a cost-effective and non-intrusive manner. Other forms of online content delivery are passive and deliver information blindly, or based on established patterns or demographics over time. Additionally, if one wants to deliver custom content in a mobile application, one needs to provide it at additional time and cost. Traditional online forms of advertising and search engine optimization cannot respond to the changing needs of a user fast enough to be efficient, nor does it help a business break through the clutter of all the other advertising that internet users are bombarded with continually.

There is a need in the art for a targeted content delivery system that addresses consumer needs and is accessible to small businesses.

### BRIEF SUMMARY

A system for delivering targeted content to consumers includes a wishlist database containing user wishlists and an institution database containing information items provided by institutions. The system further includes a computer having an analyzer that determines if an item on a user wishlist matches an item in the institution database. The computer further includes a display that graphically displays items in the institution database that match items on the user wishlist. The computer further includes an updater that updates the wishlist database and institution database with changes from users and institutions.

In some embodiments, the computer further includes a notifier that notifies the user if an item in the institution database matches an item on the user's wishlist. In some embodiments, the updater updates the wishlist database and institution database with changes from administrators of the system. In some embodiments, the information items include news, events, deals, discounts, training, and job opportunities. In some embodiments, the display is generated by a mobile application. In some embodiments, the user is active duty military, a veteran, or a military dependent. In some embodiments, the information items include news, events, deals, discounts, training, and job opportunities for veterans.

A method of delivering targeted content to consumers, includes querying a user for events, opportunities, and products they desire via software executing on a computer. The method further includes assembling a wishlist of user desires collected via software executing on a computer. The method further includes querying an institution for events, opportunities, or discounts they provide via software executing on a computer. The method further includes assembling an available list of events, opportunities, or discounts provided by the businesses via software executing on a computer. The method further includes determining if any items on the wishlist match items on the available list via software executing on a computer. The method further includes displaying any matches determined to the user via software executing on a computer.

In some embodiments, the method further includes notifying the user if a match is found via software executing on a computer. In some embodiments, the method further includes updating the wishlist and available list with changes from users and institutions via software executing on a computer. In some embodiments, the method further includes updating the wishlist and available list with changes from administrators via software executing on a computer. In some embodiments, the events, items, or discounts on the available list include news, events, deals, discounts, training, and job opportunities. In some embodiments, the displaying step is performed by a mobile application. In some embodiments, the user is active duty military, a veteran, or a military dependent. In some embodiments, the events, items, or discounts on the available list include news, events, deals, discounts, training, and job opportunities for veterans.

### BRIEF DESCRIPTION OF THE DRAWINGS

FIG. 1 is a block diagram of the system according to one embodiment.

FIG. 2 is a flow-chart representation of the method according to the embodiment shown in FIG. 1.

### DETAILED DESCRIPTION

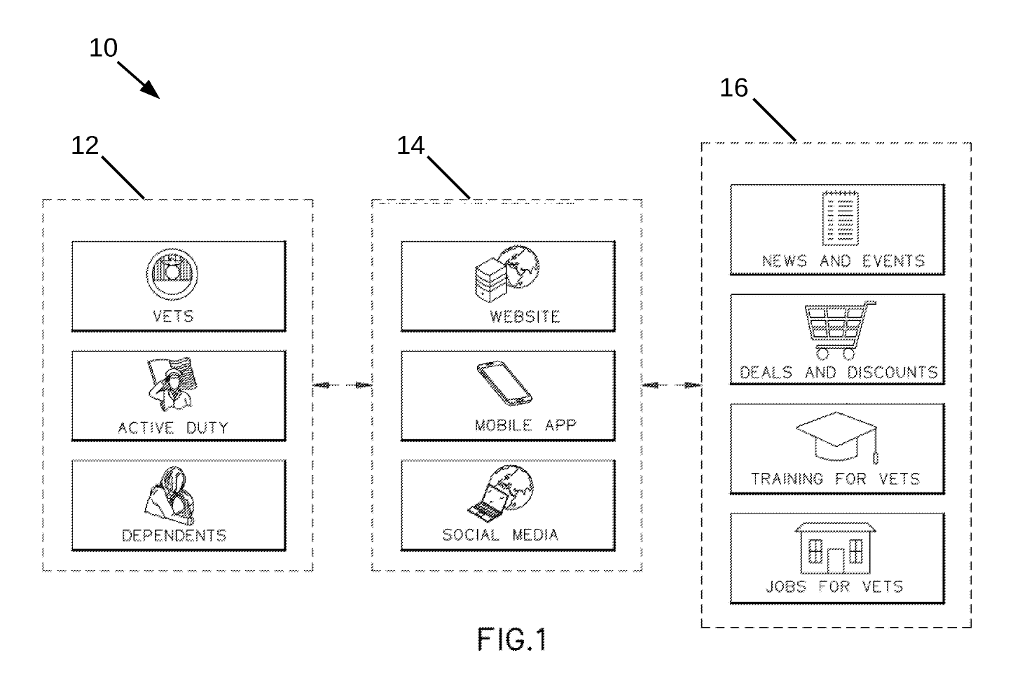

FIG. 1 is a block diagram of the system 10 according to one embodiment. Users 12, which include vets, active duty, and military dependents in this embodiment, access the database 16 through the software client 14. Software client 14 includes a website client, mobile application (or “app” as referred to herein), or a social media page for system 10. Software client 14 accesses database 16, which includes opportunities, events, and discounts. In this embodiment, database 16 includes news and events, deals and discounts, training for vets, and jobs for vets. The items in database 16 are targeted towards users 12. Software client 14 determines matches between the wishlists of users 12 and the items in database 16. Software client 14 then notifies and displays the matches to users 12. The method 20 described herein can be performed on the software system 10 described herein.

By constantly checking between a user's different wishlists and database 16, the level of efficiency and responsiveness from a user perspective is increased without burying the user 12 in online mass-marketing. Because the institutional users are ultimately publishing information to a mobile application, it allows them to get all the advantages of a proprietary application without the associated cost, time, and effort.

The system and method described herein allow for the user 12 to create a custom wishlist for each category of content available on the software client 14. Therefore, a user 12 can create a persistent list of words for each area that they can change in near real-time. Each user wishlist checks all content on database 16 provided under each section for any matches. If there is one, user 12 gets a visual notification and can go directly to the items that match what they are looking for. Anyone with an account on software client 14 can create custom content for delivery to other users 12.

The system and method described herein synchronize user-created content and business advertising between software client 14 and database 16 every few minutes to check for new content. If something new is found, it is delivered to the end-user's software client 14 on his smartphone or elsewhere, without the need for the person generating the content to have a proprietary smartphone application. This feature allows both consumers and institutions/business users to reach each other without all the clutter of online mass marketing or the need to develop a proprietary mobile application for it.

Basic Search Engine Optimization and traditional online advertising not only minimizes the consumer needs, it exposes user patterns and preferences in ways users 12 may not want - a user 12 knows what they want, they just may not know how to find it. This combination of passive notification and user-defined wishlists bypasses all the issues and makes the user 12 the optimization engine. Additionally, since all wishlist information is stored locally on the user's phone, it is not exposed for exploitation as easily as systems on the market today.

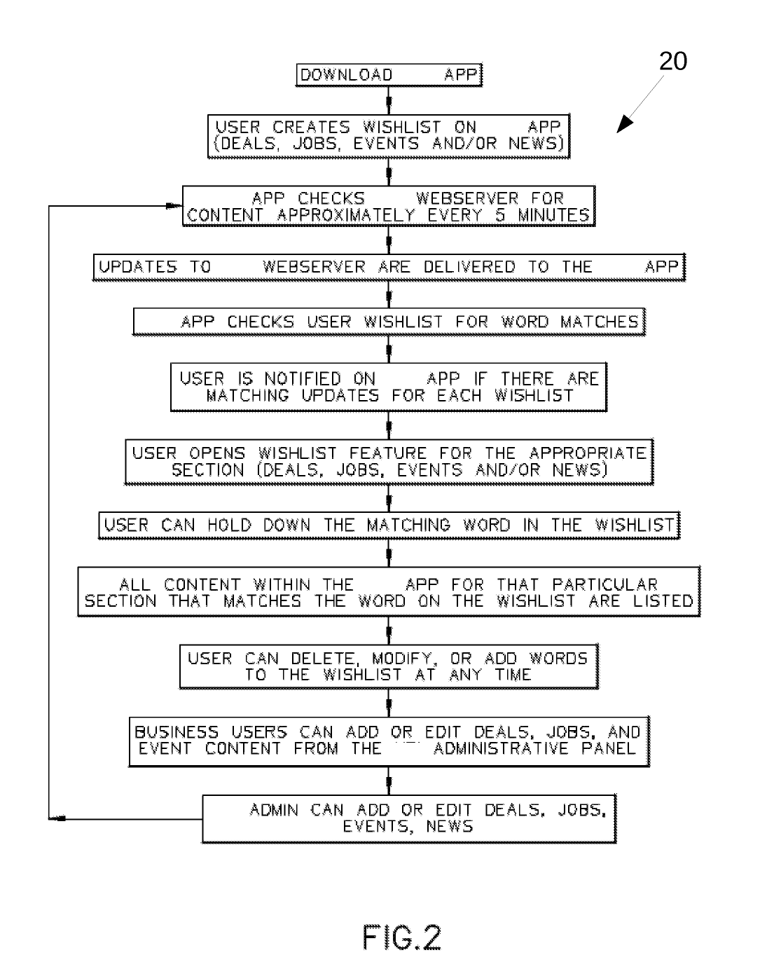

FIG. 2 shows a flow chart for a method 20 according to one embodiment.

In some embodiments, method 20 includes the following steps:

1. User 12 signs up for an account on the website or downloads the app.

2. User 12 (an administrator in some embodiments) creates content via the website in deals/discounts, news, events, or training. This user 12 may be employed by an institution providing these deals/discounts, news, events, or training.

3. User 12 creates text content and can include a graphic, start/stop dates, and additional referral links that can link to any other page on the web that is accessible.

4. Created content is reviewed by an administrator for approval.

5. Upon approval, content is added to database 16 and published to the server in the appropriate areas - and can be accessible from software client 14.

6. User 12 downloads the app from a digital distribution platform

7. User 12 creates a wishlist (a collection of words of interest to user 12) for each area as desired for Deals and Discounts, Jobs and Training, Events,

News and/or Training (institution generated content).

8. Each wishlist is persistent and is associated with each section and unique to each user 12.

9. Software client 14 checks the web server every few minutes to see if there is a match between content created by a user or institution and any words on the wishlist of user 12.

10. If there is a match, the software client 14 counts how many words match and displays that number (such as in a small circle at the top right hand side of the appropriate wishlist in each section and a push notification on the top portion of the mobile device display).

11. User 12 can touch the wishlist button to get the entire list of words.

12. Wishlist words that resulted in a match can then be pressed individually and another menu appears that provides at least three choices: 1. Delete, 2. Get Match, and 3. Cancel

13. When user 12 implements step 12, the display will then show all content that matches the words in the wishlist, per section.

14. User 12 can change each wishlist anytime they want, and when software client 14 searches database 16 again, it takes the new changes into account during the search.

15. Each deal and discount created by an institution or user 12 auto-generates a random code (or any code) that displays along with the deal and discount content.

16. User 12 applies for a job via software client 14 and selects from a series of questions to indicate interest and qualifications, not necessarily in free-form text but using radial/binary choices (such as Yes/No answers (binary), or answers chosen by clicking a button out of a collection of buttons that represent various choices (radial)) that are delivered to server 16.

17. Job posters (or institutions) can then view the answers to those binary questions to provide an initial first screening of applicants much faster than with a pure resume search.

18. Job posters get an email notification if anyone applies for a job over the website or the application.

Database 16 must be created to specifically synchronize with a software client 14 by user 12, by wishlist. The application makes a web service call to the server at an interval of every few minutes and checks for any new content that matches a wishlist in one of at least four areas: deals and discounts, jobs and training, events, and news. So even if a user 12 changes a wishlist, the software client 14 makes the same web service call just using the current parameters to justify what content to alert the user 12 about. In some embodiments, software client 14 interfaces with web mapping services and supports location-based content delivery, and displays in the deals and discounts if a user 12 has put in a location or GPS coordinates.

User 12 can respond to the jobs and training section by filling out a job application via software client 14. The job application is then sent to the server and delivered to the system administrator and the entity that posted the job content. The web user-interface on the back-end supports several forms of content (such as HTML, Flash, Rich Text, Video files for events) that can be visualized inside a web portlet. If any new content matches any user 12 wishlist words, then the content associated with those words is specifically delivered to that individual user 12. If the content created is not active (expired, for instance), it will not be displayed. Content will move into an inactive state if the publication date of the content has passed. In some embodiments, if user 12 provides words on the wishlist for content and there is no match, then no wishlist alert will show, but all active content will show regardless. If new content is created that matches a previously created wishlist item, then the user 12 will get an alert (such as visual and/or numeric) on the appropriate wishlist. If user wishlist word(s) match to content in database 16, software client 14 will send a notification to user 12.

In some embodiments, software client 14 includes a website that interacts with a specific mobile applications (on iOS, android, Windows Phone, or any other mobile OS) through web service calls. In some embodiments, software client 14 interfaces with the website to look for new content and then alert a user 12 when there was a match using the wishlist feature. In some embodiments, the user can access database 16 through a social media application.

In some embodiments, software client 14 imports features provided by search engines that could make the visualization and map searches much more robust. In some embodiments, the website side is moved to a web portlet environment with more built-in features as a part of a freeware enterprise solution. In that embodiment, the mobile application side remains the same, but may take advantage of the deeper integration platform of a customizable and modular web portlet environment. The web portlet environment allows for customization of users 12 as a part of a user 12 group, or specific permissions based on organization. This environment builds a tighter community approach, so users 12 would still get better results in near real-time and the user experience is better.

This combination of passive notification and user-defined wishlist bypasses all the issues and makes the user the optimization engine. Additionally, since all wishlist information is stored locally on the user's phone in some embodiments, it is not exposed for exploitation as easily as current methods.

Although the invention has been described with reference to embodiments herein, those embodiments do not limit the invention. Modifications to those embodiments or other embodiments may fall within the scope of the invention.

What is claimed is:

1. A system for delivering targeted content to consumers, comprising:
a wishlist database containing user wishlists;
an institution database containing information items provided by institutions;
a computer having:
an analyzer that determines if an item on a user wishlist matches an item in the institution database;
a display that graphically displays items in the institution database that match items on the user wishlist; and
an updater that updates the wishlist database and institution database with changes from users and institutions.

2. The system of claim 1, wherein the computer further comprises:
a notifier that notifies the user if an item in the institution database matches an item on the user's wishlist.

3. The system of claim 1, wherein the updater updates the wishlist database and institution database with changes from administrators of the system.

4. The system of claim 1, wherein the information items include news, events, deals, discounts, training, and job opportunities.

5. The system of claim 1, wherein the display is generated by a mobile application.

6. The system of claim 1, wherein the user is active duty military, a veteran, or a military dependent.

7. The system of claim 6, wherein the information items include news, events, deals, discounts, training, and job opportunities for veterans.

8. A method of delivering targeted content to consumers, comprising:
(a) querying a user for events, opportunities, and products they desire via software executing on a computer;
(b) assembling a wishlist of user desires collected in step (a) via software executing on a computer;
(c) querying an institution for events, opportunities, or discounts they provide via software executing on a computer;
(d) assembling an available list of events, opportunities, or discounts provided by the businesses via software executing on a computer;
(e) determining if any items on the wishlist match items on the available list via software executing on a computer; and
(f) displaying any matches determined in step (e) to the user via software executing on a computer.

9. The method of claim 8, further comprising:
(g) notifying the user if a match is found in step (e) via software executing on a computer.

10. The method of claim 8, further comprising:
(g) updating the wishlist and available list with changes from users and institutions via software executing on a computer.

11. The method of claim 8, further comprising:
(g) updating the wishlist and available list with changes from administrators via software executing on a computer.

12. The method of claim 8, wherein the events, items, or discounts on the available list include news, events, deals, discounts, training, and job opportunities.

13. The method of claim 8, wherein step (f) is performed by a mobile application.

14. The method of claim 8, wherein the user is active duty military, a veteran, or a military dependent.

15. The method of claim 14, wherein the events, items, or discounts on the available list include news, events, deals, discounts, training, and job opportunities for veterans.
